(19) United States
(12) Patent Application Publication
(10) Pub. No.: US 2016/0379253 A1
(43) Pub. Date: Dec. 29, 2016

(54) DYNAMIC GENERATION OF ADVERTISEMENT BASED UPON USER NEED

(71) Applicant: International Business Machines Corporation, Armonk, NY (US)

(72) Inventors: Yuk L. Chan, Rochester, NY (US); Lawrence A. Clevenger, LaGrangeville, NY (US); Deepti M. Naphade, Fishkill, NY (US)

(73) Assignee: INTERNATIONAL BUSINESS MACHINES CORPORATION, Armonk, NY (US)

(21) Appl. No.: 14/840,119

(22) Filed: Aug. 31, 2015

Related U.S. Application Data
(63) Continuation of application No. 14/753,045, filed on Jun. 29, 2015.

(51) Int. Cl. G06Q 30/02; H04L 29/08; G06Q 50/00

(52) U.S. Cl. CPC G06Q 30/0255; G06Q 50/01; H04L 67/22

(57) ABSTRACT

Provided are techniques for the generation of advertising content based upon users' needs and use cases. The techniques include monitoring social media to generate a history of user interest; identifying a current interest of a user based upon information derived from a group of sources, the first group of sources comprising: social media data corresponding to the user; communications to and from the user; interactions between the user and other users; calendar entries of the user; and a location corresponding to the user; predicting a user case corresponding to a product such that the use case conforms to the current interest; generating an advertisement based upon the use case and a second group of sources, the second group of sources comprising literature corresponding to the product; user feedback with respect to the product; user ratings of the product; and blogs referencing the product; and displaying the advertisement to the user.

### CROSS-REFERENCES TO RELATED APPLICATIONS

The present application is a continuation and claims the benefit of the filing date of an application entitled, “Dynamic Generation of Advertisement Based Upon User Need” Ser. No. 14/753,045, filed Jun. 29, 2015, assigned to the assignee of the present application, and herein incorporated by reference.

### FIELD OF DISCLOSURE

The claimed subject matter relates generally to the generation of advertisements and, more specifically, to techniques for the generation on online advertisements based upon benefits and needs of a user rather than the features of a product.

### BACKGROUND OF THE INVENTION

Currently, typical online advertisements simply show an image of a particular product with a listing of a few of the product's features. This is a different approach than that which would be taken by an experienced sales person. An experienced sales person typically presents to a potential buyer the product's benefits, i.e., features that may benefit the potential buyer based upon the buyer's specific needs. Since the ultimate goal of an advertisement is to sell a product rather than merely to show the product, the latter approach is typically more effective than the former. However, as stated above, typically online advertisements are generated based upon the former rather than the latter approach.

One current approach is to generate text for an advertisement based upon user and advertiser information including user behavior attributes, such as browsing, publishing and purchasing histories, user demographic attributes, such as gender, income, and spoken language, and advertiser attributes, such as the advertiser's particular industry. Advertising text is generated using a text authoring engine, which might include natural language processing, based upon the user and advertiser's attributes.

Another current approach is one in which advertisement content is selected based upon customer profiles, which may include general demographics such as age, sex, income level, zip code and known likes and interests of the buyer. In addition, advertisements may be linked to associated banner advertisements to provide more intense targeting. This type of approach may depend upon static profile descriptions.

### SUMMARY

Provided are techniques for the dynamic generation of advertising content based upon users' needs and use cases. The techniques include monitoring social media to generate a history of user interest; identifying a current interest of a user based upon information derived from a group of sources, the first group of sources comprising: social media data corresponding to the user; communications to and from the user; interactions between the user and other users; calendar entries of the user, and a location corresponding to the user; predicting a user case corresponding to a product such that the use case conforms to the current interest; generating an advertisement based upon the use case and a second group of sources, the second group of sources comprising literature corresponding to the product; user feedback with respect to the product; user ratings of the product; and blogs referencing the product; and displaying the advertisement to the user. This summary is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed description.

### BRIEF DESCRIPTION OF THE DRAWINGS

A better understanding of the claimed subject matter can be obtained when the following detailed description of the disclosed embodiments is considered in conjunction with the following figures, in which:

FIG. 1 is a block diagram of an example of an Advertising Generation (ADG) architecture that may implement the claimed subject matter.

FIG. 2 is a block diagram of an example of an Advertising Generation Engine (ADGE). first introduced above in conjunction with FIG. 1, in greater detail.

FIG. 3 is an illustration of a monitor, first introduced above in conjunction with FIG. 1, displaying an advertisement in accordance with the claimed subject matter.

FIG. 4 is a flowchart of an example of a “Determine User Need” process that may implement aspects of the claimed subject matter.

FIG. 5 is a flowchart of an example of a “Determine Use Cases and Features” process that may implement aspects of the claimed subject matter.

FIG. 6 is a flowchart of an example of a “Generate Advertisement” process that may implement aspects of the claimed subject matter.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manutfacture including instructions which implement the function/act specified in the flowchart and/or block diagram block or blocks.

The computer program instructions may also be loaded onto a computer, other programmable data processing apparatus, or other devices to cause a series of operational actions to be performed on the computer, other programmable apparatus or other devices to produce a computer implemented process such that the instructions which execute on the computer or other programmable apparatus provide processes for implementing the functions/acts specified in the flowchart and/or block diagram block or blocks.

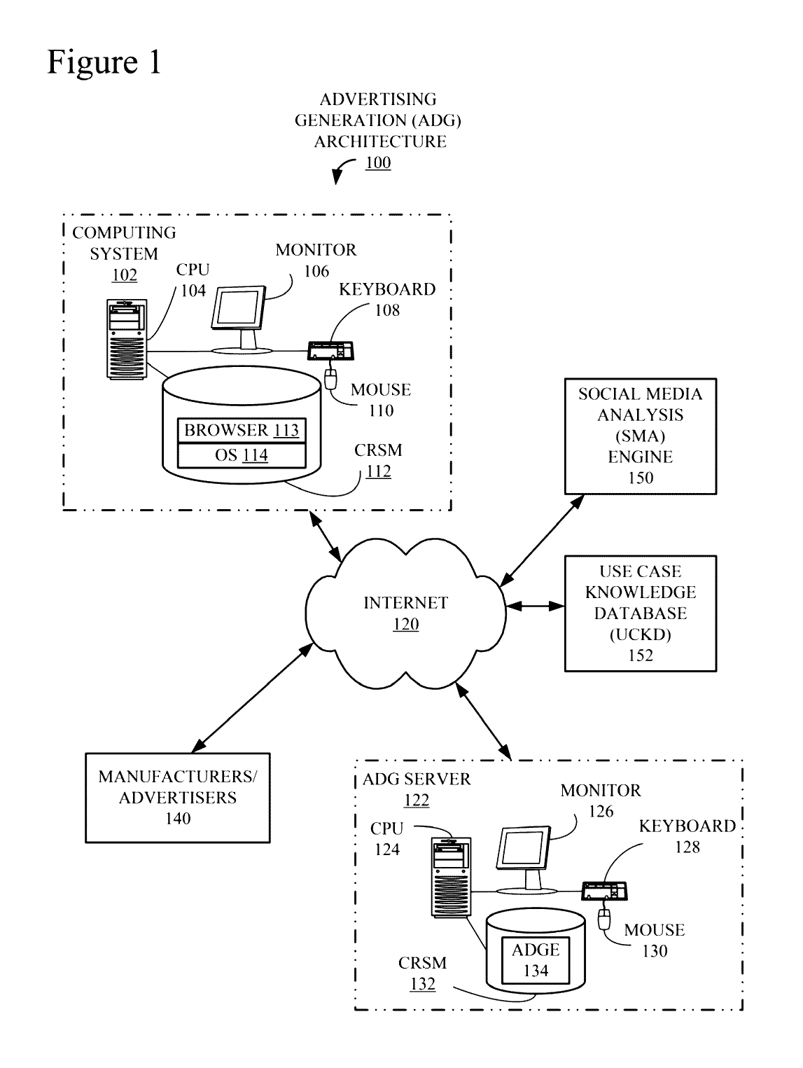

Turning now to the figures, FIG. 1 is a block diagram of an example of an Advertising Generation (ADG) architecture 100 that may implement the claimed subject matter. A computing system 102 includes a central processing unit (CPU) 104, which may include one or more processors (not shown), coupled to a monitor 106, a keyboard 108 and a pointing device, or “mouse,” 110, which together facilitate human interaction with computing system 102 and other elements of architecture 100. Also included in computing system 102 and attached to CPU 104 is a computer-readable storage medium (CRSM) 112, which may either be incorporated into computing system 102 i.e. an internal device, or attached externally to CPU 104 by means of various, commonly available connection devices such as but not limited to, a universal serial bus (USB) port (not shown). CRSM 112 is illustrated storing an Internet browser, or simply “browser,” 113 and an operating system (OS) 114. It should be noted that a typical computing system would include more components and applications, but for the sake of simplicity only a few necessary for the following description are shown. It should also be understood that browser 113 is only one example of a user technology that may be impacted by the claimed subject matter. Other examples include, but are not limited to, television, audio and video streaming media, internet telephone service and ad-based gaming.

Computing system 102 and CPU 104 are connected to the Internet 120, which is also connected to an Advertising Generation (ADG) server 122, various systems associated with manufacturers/advertisers 140, a social media analysis (SMA) engine 150, and a use case knowledge database (UCKD) 152. Although in this example, computing system 102, ADG server 122, manufacturers/advertisers 140, SMA engine 150 and UCKD 152 are communicatively coupled via the Internet 120, they could also be coupled through any number of communication mediums such as, but not limited to, a local area network (LAN) (not shown), direct wired connections (not shown) and the public telephone system (POTS) (not shown).

Like computing system 102, ADG server 122 includes a CPU 124 with one or more processors (not shown), a monitor 126, a keyboard 128, a mouse 130 and a CRSM 132. In this example CRSM 132 is illustrated storing logic associated with an ADG engine (ADGE) 134 that implements aspects of the claimed subject matter.

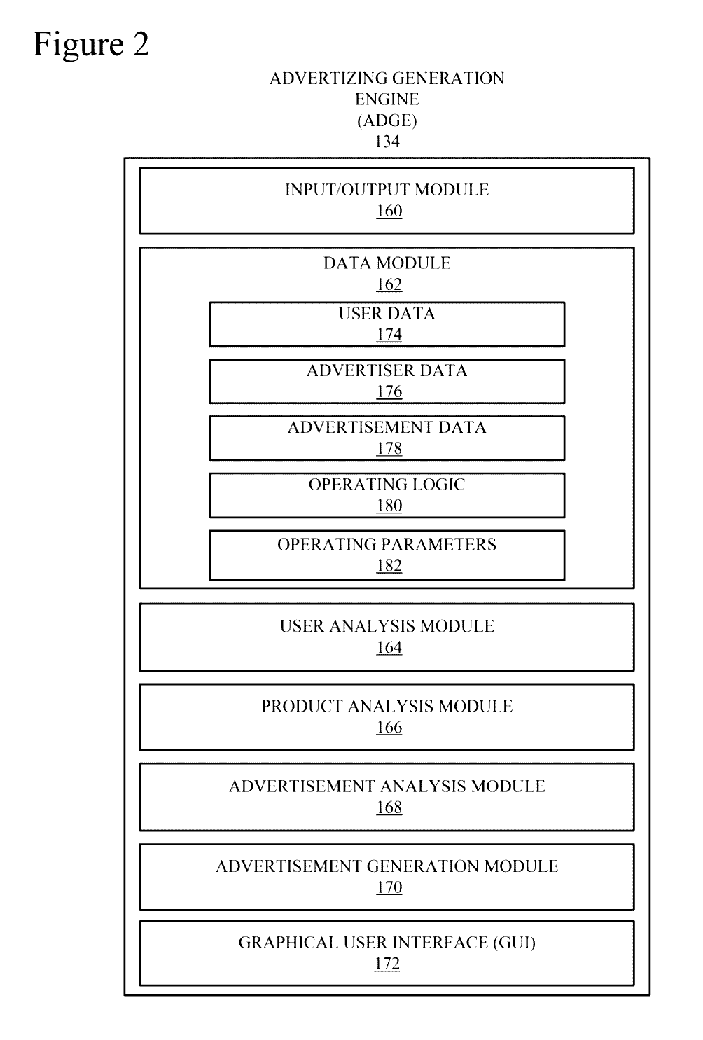

Although not illustrated manufacturers/advertisers 140, SMA engine 150 and UCKD 152 would also include components like computing system 102. It should be noted there are many possible system configurations, of which ADG architecture 100 is only one simple example. The interaction and functionality of components 102, 122, 134, 140, 150 and 152 are described in more detail below in conjunction with FIGS. 2-6.

FIG. 2 is a block diagram of Advertising Generation Engine (ADGE) 134, first introduced above in conjunction with FIG. 1, in greater detail. ADGE 134 includes an input/output (I/O) module 160, a data module 162, a user analysis module 164, a product analysis module 166, an advertisement analysis module 168, an advertisement generation module 170 and a graphical user interface (GUI) 172. For the sake of the following examples, logic associated with ADGE 134 is assumed to execute on ADG server 122 (FIG. 1) and be stored on CRSM 132 (FIG. 1). It should be understood that the claimed subject matter can be implemented in many types of computing systems and data storage structures but, for the sake of simplicity, is described only in terms of computer 122 and architecture 100 (FIG. 1). Further, the representation of ADGE 134 in FIG. 2 is a logical model. In other words, components 160, 162, 164, 166, 168, 170 and 172 may be stored in the same or separates files and loaded and/or executed within ADG server 122 and system 100 either as a single system or as separate processes interacting via any available inter process communication (IPC) techniques.

I/O module 160 handles any communication ADGE 134 has with other components of ADG server 122 and architecture 100. Data module 162 is a data repository for information that ADGE 134 requires during normal operation. Examples of the types of information stored in conjunction with data module 162 include user data 174, advertiser data 176, advertisement data 178, operating logic 180 and operating parameters 182.

User data 174 stores information on particular users for whom advertisements are generated for display. Users may be selected to receive advertisements generated in accordance with the claimed subject matter based upon lists of potential consumers or by enabling users to sign up for the service offered. User data 174 may include, but is not limited to, users' demographic information such as gender, income, spoken language, age etc., and users' behavior attributes such as browsing history, purchasing history, publishing history, etc. Additional sources of user data 174 may include social media data corresponding to the user, communications to and from the user interactions between the user and other users; calendar entries of the user; and a location corresponding to the user;

Advertiser data 176 stores information on business entities such as manufacturers, retailer and other businesses or non-profits that desire to employ the claimed subject matter to make displayed advertisements and messages more efficient at informing users and consumers of their options with respect to businesses offerings. Such data may information either product information or the location of sources of product information. Such product information may include, but is not limited literature corresponding to the product, user feedback with respect to the product, user ratings of the product and blogs referencing the product. Products may be, but are not limited to, a service, merchandise, accessories, and consumables. Advertising data 178 stores information on the advertisements that may be modified in accordance with the disclosed technology.

Operating logic 180 stores executable code that implements aspects of the claimed subject matter. Operating parameters 182 stores variables that control the operation of ADGE 134. The variables of operating parameters 182 are typically set by an administrator with the aid of GUI 172.

User Analysis module 164 parses user data 174 to determine users' needs. For example, a social network post corresponding to a particular user may determine if the post is related to activities that might be product related, such as “The user is making Soy Milk or “The user is making pizza dough.” Additional information related to the activities may also be ascertained such as “the Soy Milk was pretty good, but it's grainy” and “the pizza dough was good and takes an hour.” In addition, User Analysis module 164 may determine specific use cases corresponding to the product needed by the user such as “There is a market for making soy milk that's not grainy” and “There is a market for making pizza dough quickly.” Such use cases may either be generated as needed or complied and stored in UCKD 152 (FIG. 1) during repeated implementation of the claimed subject matter and retrieved as needed.

Product Analysis module 166 parses data relating to products to identify use scenarios, or “use cases.” For example module 166 may determine if a product's manufacturer officially supports a particular use case based upon information in the manufacturers' own sources. Examples of sources include, but are not limited to, manufacturer's user guides, websites or user reviews that indicate the product has been used for similar a use case. In addition, user feedback may be employed to calculate statistics based on a product's use case and user feedback to generate support statements. Specific examples of support statements may include such statement as “Ninety percent (90%) of users purchase this soy milk machine to make veggie juice; eighty percent (80%) of users are happy with the texture of the juice; and seventy percent (70%) of users are happy with the ease of cleaning for juice.”

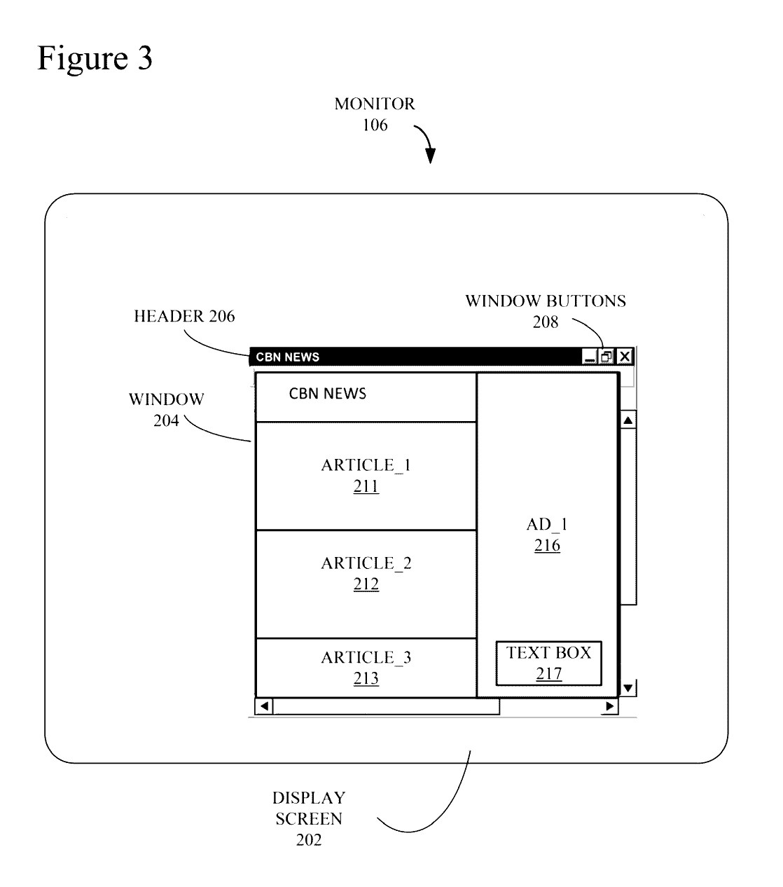

Advertising analysis module 168 generates information relating to advertising that may be manipulates in accordance with the disclosed techniques. Such information may include the elements of particular advertisements and the relative effectiveness of those particular elements with respect to specific demographics of users. Advertisement Generation module 170 employs the information generated by modules 164, 166 and 168 to tailor advertisements to specific users. Components 160, 162, 164, 166, 168, 170, 172, 174, 176 178, 180 and 182 are described in more detail below in conjunction with FIGS. 3-6. GUI component 148 enables users of ADGE 134 to interact with and to define the desired functionality of ADGE 134, typically by the setting of variables (not shown) in operating parameters 182.

FIG. 3 is an illustration of monitor 106 (FIG. 1) of computing system 102 (FIG. 1) with a display screen 202 and a window 204 on display screen 202. The elements of FIG. 3 are used as examples throughout the rest of the Specification. In this example, window 204 corresponds to an example of Internet news service. A header 206 displays the title of window 204 and the corresponding Internet news service, i.e., “CBN News.” It should be understood the monitor 106 and window 204 are merely one example of an advertising medium that may be implemented in accordance with the claimed subject matter. Other advertisement mediums and presentation devices may include, but are not limited to, televisions, radios, mobile telephones, computers, and so on.

Window 204 is generated by browser 113 (FIG. 1) in response to a user's navigation of the Internet 120 (FIG. 1). As is typical in browser windows, window 204 may include several windows buttons 208, which in this example are a “Minimize” button, a “Restore” button and an “Exit” button. The standard look and feel of an Internet window should be familiar to those with skill in the relevant arts. The particular web site displayed, i.e., “CBN News,” includes a number of news articles, i.e., an article_1 211, an article_2 212 and an article 3 213. Beside articles 211-213 is a display advertisement, i.e., an AD_1 216. AD_1 216 is used as an example of an advertisement generated in accordance with the claimed subject matter. Within AD_1 216 is a text box 217, which is provided to enables a user viewing the advertisement to type and forward a question, review, feedback concerning the product or advertisement and so on to the manufactures or business corresponding to AD_1 216. In this manner, a user's questions, feedback and comments about a product may be handled.

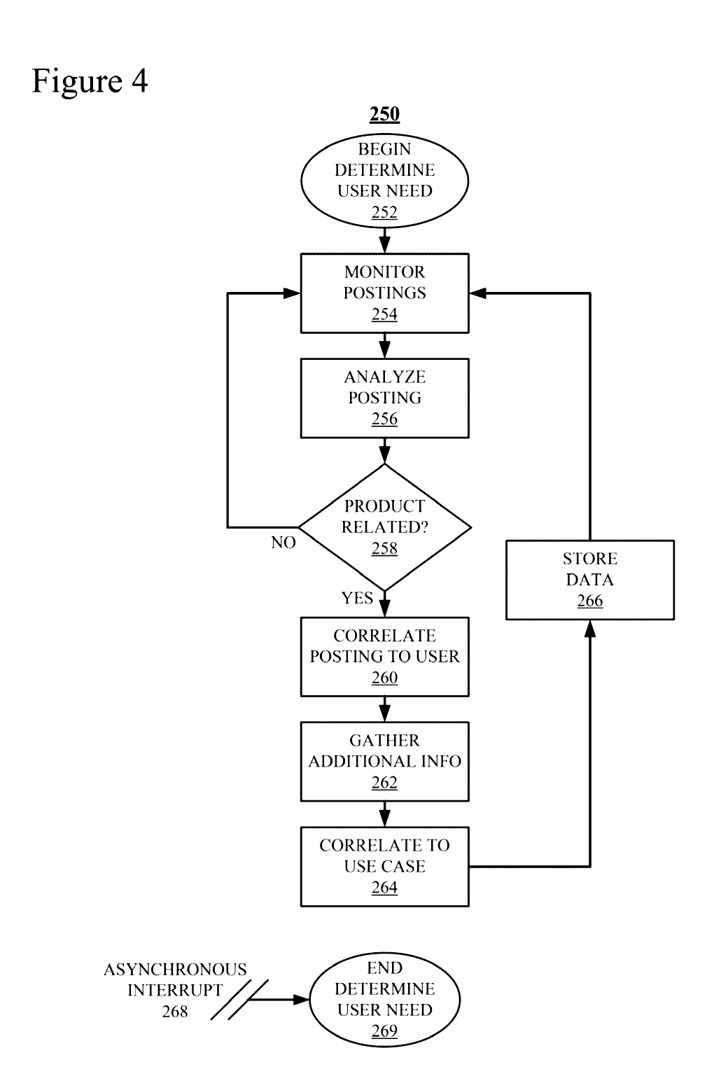

FIG. 4 is a flowchart of an example of a “Determine User Need” process 250 that may implement aspects of the claimed subject matter. In this example, logic associated with process 250 is stored on a CRSM (not shown) and executed on one or more processors (not shown) of SMA engine 150 (FIG. 1).

Process 250 starts in a “Begin Determine User Need” block 252 and proceeds immediately to a “Monitor Postings” block 254. During processing associated with block 254, social network postings are scanned. During processing associated with an “Analyze Posting” block 256, each posting is analyzed for indications that a product being managed in accordance with the disclosed technology is involved. During processing associated with a “Product Related?” block 256, a determination is made as to whether or not the posting received during processing associated with block 254 is related to such a product, or a “product of interest.” If not, control returns to block 254 and the monitoring of social network postings continues. A product of interest may be identified by text within the posting such as, “I am making Soy Milk” or “I am making pizza dough.”

If, during processing associated with block 258, a determination is made that a product of interest is involved, control proceeds to a “Correlate Posting to User” block 260. During processing associated with block 260, the user that corresponds to the posting analyzed during processing associated with block 256 is noted. During processing associated with a “Gather Additional Info” block 262, additional information related to activities described in the posting is gathered. For example, using the soy milk and pizza dough examples introduced above, a user may indicate. “The Soy Milk was pretty good, but it's grainy” or “The pizza dough was good but it took an hour.”

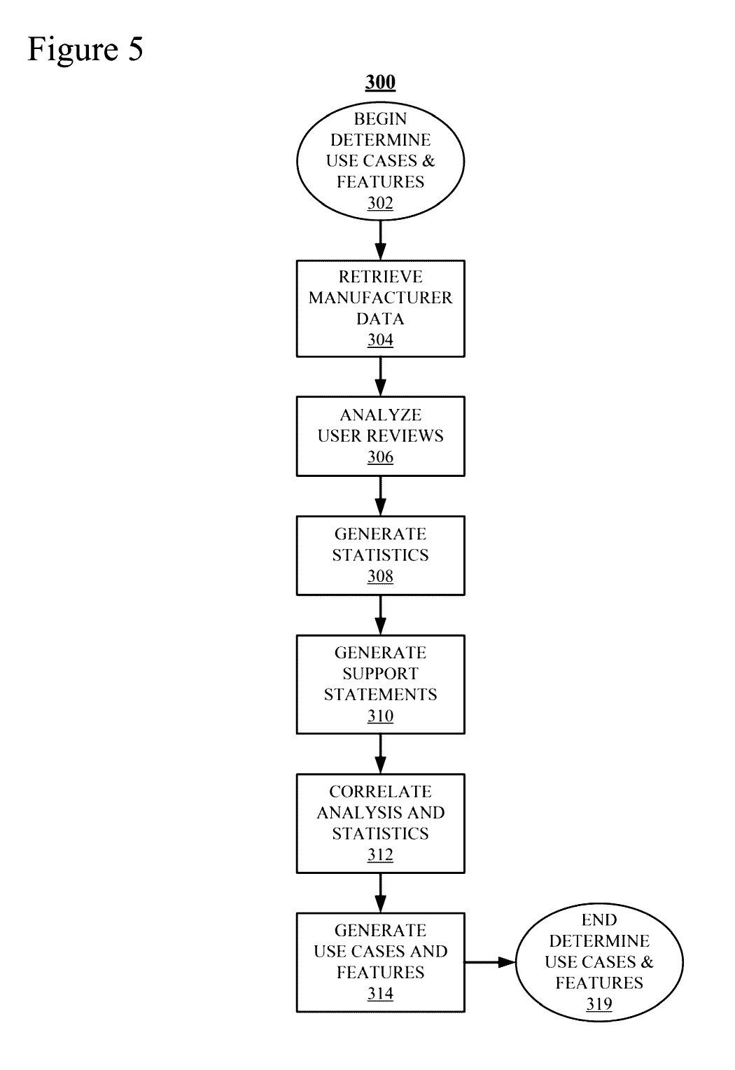

During processing associated with a “Correlate to Use Case” block 264, the information gathered during processing associated with block 262 is used to determine any specific use case related to the product of interest that may be needed by the user identified during processing associated with block 260. For example, use cases may include, “Make soy milk that is not grainy” and “Make a pizza dough that can be prepared quickly.” Other sources of information may include, but is not limited to, information such as web pages and product documentation from manufacturers/advertisers (see 140, FIG. 1; 300. FIG. 5).

During processing associated with a “Store Data” block 266, the information collected during processing associated with block 262 and the use cases generated during processing associated with block 264 are stored by SMA engine 150 so that the information Is available for other aspects of the claimed subject matter. Control then returns to block 254 and processing continues as describe above.

Finally, process 250 is halted by means of an asynchronous interrupt 268, which passes control to an “End Determine User Need” block 269 in which process 250 is complete. Interrupt 268 is typically generated when the application, computing system, etc. of which process 250 is a part is itself halted. During normal operation, process 250 continuously loops through the blocks 254, 256, 258, 260, 262, 264 and 266, processing social network postings as users generate them.

FIG. 5 is a flowchart of an example of a “Determine Use Cases and Features” process 300 that may implement aspects of the claimed subject matter. In this example, logic associated with process 300 is stored on a CRSM 132 (FIG. 1) in conjunction with ADGE 134 (FIG. 1) and executed on one or more processors (not shown) of CPU 124 (FIG. 1) of ADG server 122 (FIG. 1).

Process 300 starts in a “Begin Determine User Cases and Features” block 302 and proceeds immediately to a “Retrieve Manufacturer Data” block 304. During processing associated with block 304, information concerning products of interest is collected from manufacturers/advertisers 140 (FIG. 1). Such information may include, but is not limited to, information gathered from web pages and product documentation. During processing associated with an “Analyze User Reviews” block 306, social network postings of user reviews are searched for information concerning products of interest. Such information may be retrieved form SMA engine 150 (FIG. 1) (see 250, FIG. 4).

During processing associated with a “Generate Statistics” block 308, use cases gathered during processing associated with block 304 and user feedback gathered during processing associated with block 306 are analyzed to generate statistics relates to products of interest. During processing associated with a “Generate Support Statements” block 310, statistics generated during processing associated with block 308 are employed to generate support statements. For example, “Ninety percent (90%) of users purchase a particular soy milk machine to make veggie juice”; “Eighty percent (80%) of the users are happy with the texture of the veggie juice”; and “Seventy percent (70%) of users are happy with the ease of cleaning the soy milk machine after making veggie juice.”

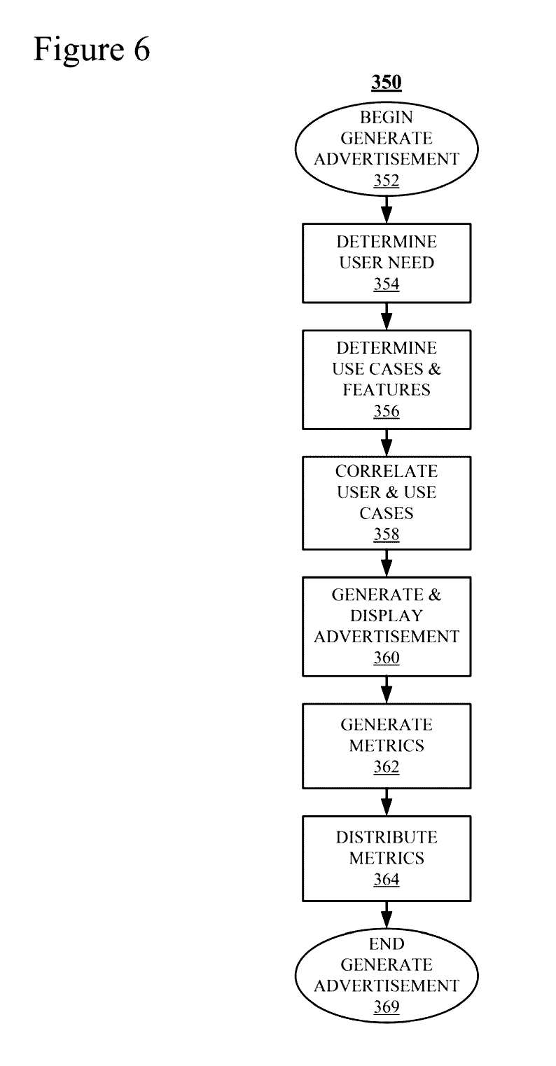

During processing associated with a “Correlate Analysis and Statistics” block 312, the analysis of user reviews performed during processing associated with block 306 and the statistics generated during processing associated with block 308 are employed to identify specific use cases that relate to specific users (see 350, FIG. 6). During processing associated with a “Generate Use Cases and Features” block 314, specific use cases are generated based the processing associated with blocks 304, 306, 308, 310 and 312. Finally, control proceeds to an “End Determine Use Cases and Features” block 319 and process 300 is complete.

FIG. 6 is a flowchart of an example of a “Generate Advertisement” process 350 that may implement aspects of the claimed subject matter. Like process 300 (FIG. 5), in this example, logic associated with process 350 is stored on a CRSM 132 (FIG. 1) in conjunction with ADGE 134 (FIG. 1) and executed on one or more processors (not shown) of CPU 124 (FIG. 1) of ADG server 122 (FIG. 1).

Process 350 starts in a “Begin Generate Advertisement” block 352 and proceeds immediately to a “Determine User Need” block 354. During processing associated with block 354, data about a particular user of interest is gathered to determine any particular needs the user may have with a product to be presented in an advertisement. For example, using the soy milk example, a determination may be may that a particular user needs a soy milk machine that does not produce a grainy milk. During processing associated with a “Determine Use Cases and Features” block 356, specific use cases and features generated for the product of interest, i.e., soy milk, previously generated (see 314, FIG. 5) are collected.

During processing associated with a “Correlate User and Use Cases” block 358, use cases and features retrieved during processing associated with block 358 are correlated with the specific user of interest. During processing associated with a “Generate and Display Advertisement” block 360, an advertisement is generated that is directed to the specific user of interest, the product of interest and the correlation between the specific user and the relevant use cases and features identified during processing associated with block 358. In this manner, advertisements may be directed to specific users in a manner not possible with current technology. In other words, based on the user needs/use case, the system identifies the product/ads requester that's most likely to satisfy the user needs. The system may select the product based on user's review related to the specific use case. e.g. Product A might have 90% satisfactory user, Product B might have 50% satisfactory user. The system could select the product based on user's level of need. This can be determined by the “strength” of words or user emotion. For example, user posted “I really hate this mixer, it keeps on overheating.” is a stronger need compare to “This mixer doesn't work well. I have to keep wait for 10 minutes after 20 minutes of use!” The medium employed for presentation of the generated advertisement may be, but is not limited to, a web page, a mobile device such as a smart telephone and an audio channel such as a streaming music service. In this example, the generated advertisement is displayed as ad_1 216 (FIG. 3) on monitor 106 (FIGS. 1 and 3).

During processing associated with a “Generate Metrics” block 362, data on the effectiveness of the advertisement generated and displayed during processing associated with block 360 is generated. For example, data may be gathered on whether or not the user actually purchased the product or clicked on a link to get more information, i.e., showed an interest in the product. In addition, based on the user needs and user review, statistics may be generates about market share and opportunity. During processing associated with a “Distribute Metrics” block 364, the information generated during processing associated with block 362 is distributed to relevant parties of manufacturers/advertisers 140 (FIG. 1), who may then consider official support statement for the use case(s). Finally, control proceeds to an “End Generate Advertisement” block 369 and process 350 is complete.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

We claim:

1. A method, comprising:
monitoring social media to generate a history of user interest;
identifying a current interest of a user based upon the history of user interest;
predicting a user case corresponding to a product such that the use case conforms to the current interest;
generating an advertisement based upon the use case and information corresponding to the product; and
displaying the advertisement to the user.

2. The method of claim 1, wherein the history of user interest is derived from a group of sources, the group of sources comprising:
social media data corresponding to the user;
communications to and from the user;
interactions between the user and other users;
calendar entries of the user; and
a location corresponding to the user;

3. The method of claim 1, wherein the information corresponding to the product is derived from a group of sources, the group of sources comprising:
literature corresponding to the product;
user feedback with respect to the product;
user ratings of the product; and
blogs referencing the product; and

4. The method of claim 1, wherein the product is selected from a group consisting of:
a service;
a merchandise;
an accessory; and
a consumable.

5. The method of claim 1, further comprising generating and transmitting to the user a response to a question, from the user, corresponding to the displaying of the advertisement.

6. The method of claim 1, further comprising providing feedback to a merchant corresponding to the product, wherein the feedback corresponds to a reaction by the user in response to the displaying of the advertisement.

7. The method of claim 1, further comprising:
generating and storing in a non-transitory computer-readable medium a use case knowledge database; and
employing the use case knowledge database for the predicting.
